(19) United States
(12) Patent Application Publication
(10) Pub. No.: US 2026/0203647 A1
(43) Pub. Date: Jul. 16, 2026

(54) SYSTEMS AND METHODS OF DATA SPLITTING FOR DEVELOPING AUTONOMY COMPUTING SYSTEMS OF AUTONOMOUS VEHICLES

(71) Applicant: Torc Robotics, Inc., Blacksburg, VA (US)

(72) Inventors: Raghav, Montreal (CA); Akshay Pai Raikar, Austin, TX (US); Savio Pereira, Austin, TX (US); Yihe Hua, Christiansburg, VA (US); Ruifang Wang, Houston, TX (US); David John Thompson, Christiansburg, VA (US); Robert Charles Kriener, Roanoke, VA (US)

(21) Appl. No.: 19/020,500

(22) Filed: Jan. 14, 2025

(51) Int. Cl. G06N 20/00; B60W 60/00

(52) U.S. Cl. CPC G06N 20/00; B60W 60/001

(57) ABSTRACT

A data split computing device for developing autonomous vehicles is provided. At least one processor of the data split computing device is programmed to receive a development dataset having scenes, at least one of the scenes having operating conditions. The at least one processor is further programmed to process, via a data split machine learning model, the development dataset. The data split machine learning model is configured to generate a mask array indicating whether a scene is to be allocated to a training dataset or a testing dataset. The at least one processor is also programmed to compute a cost function based on the mask array, and optimize the data split machine learning model to balance distribution of the operating conditions. The at least one processor is programmed to split the development dataset into the training and testing datasets and output the training and testing datasets.

### TECHNICAL FIELD

The field of the disclosure relates generally to autonomous vehicles and, more specifically, to data splitting for developing autonomy computing systems in autonomous vehicles.

### BACKGROUND OF THE INVENTION

An autonomous vehicle relies on its autonomy computing system to perceive the environment in which the autonomous vehicle is operating or traveling, and plan and control the operation of the autonomous vehicle in the environment based on the perception. The autonomy computing system includes one or more machine learning models. In developing a machine learning model, a development dataset is used and split into a training dataset and a testing dataset. The training dataset is used to train the machine learning model, while the testing dataset is used to test the performance of the trained machine learning model. The testing dataset and the training dataset do not overlap, where the training dataset is not used in testing and vice versa, the testing dataset is not used in training, such that the performance of the machine learning model may be evaluated. The split of a development dataset, therefore, may affect testing results of the machine learning model. Accordingly, it is desirable to provide systems and methods for improved data splitting between the training dataset and the testing dataset for developing autonomy computing systems of autonomous vehicles.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a data split computing device for developing an autonomy computing system of an autonomous vehicle is provided. The data split computing device includes at least one processor in communication with at least one memory device. The at least one processor is programmed to receive a development dataset having a plurality of scenes of environments in which an autonomous vehicle could operate, at least one of the plurality of scenes having one or more operating conditions in the environments, the development dataset to be used for developing an autonomy computing system of the autonomous vehicle. The at least one processor is further programmed to process, via a data split machine learning model, the development dataset, wherein the data split machine learning model is configured to generate a mask array, the mask array indicating whether a scene in the plurality of scenes is to be allocated to a training dataset or a testing dataset of developing the autonomy computing system. The at least one processor is also programmed to compute a cost function based on the mask array, and optimize the data split machine learning model by optimizing the cost function to balance distribution of the one or more operating conditions between the training dataset and the testing dataset. In addition, the at least one processor is programmed to split the development dataset into the training dataset and the testing dataset based on a mask array generated by an optimized data split machine learning model and output the training dataset and the testing dataset.

In another aspect, a method of data splitting for developing an autonomy computing system of an autonomous vehicle is provided. The method includes receiving a development dataset having a plurality of scenes of environments in which an autonomous vehicle could operate, at least one of the plurality of scenes having one or more operating conditions in the environments, the development dataset to be used for developing an autonomy computing system of the autonomous vehicle. The method also includes processing, via a data split machine learning model, the development dataset, wherein the data split machine learning model is configured to generate a mask array, the mask array indicating whether a scene in the plurality of scenes is to be allocated to a training dataset or a testing dataset of developing the autonomy computing system. The method further includes computing a cost function based on the mask array, and optimizing the data split machine learning model by optimizing the cost function to balance distribution of the one or more operating conditions between the training dataset and the testing dataset. In addition, the method includes splitting the development dataset into the training dataset and the testing dataset based on a mask array generated by an optimized data split machine learning model, and outputting the training dataset and the testing dataset.

In one more aspect, one or more non-transitory machine-readable storage media for data splitting for developing an autonomy computing system of an autonomous vehicle are provided. The one or more non-transitory machine-readable storage media include a plurality of instructions stored thereon that, in response to being executed, cause a system to receive a development dataset having a plurality of scenes of environments in which an autonomous vehicle could operate. At least one of the plurality of scenes has one or more operating conditions in the environments, the development dataset to be used for developing an autonomy computing system of the autonomous vehicle. The plurality of instructions further cause the system to process, via a data split machine learning model, the development dataset, wherein the data split machine learning model is configured to generate a mask array, the mask array indicating whether a scene in the plurality of scenes is to be allocated to a training dataset or a testing dataset of developing the autonomy computing system. The plurality of instructions also cause the system to compute a cost function based on the mask array, and optimize the data split machine learning model by optimizing the cost function to balance distribution of the one or more operating conditions between the training dataset and the testing dataset. In addition, the plurality of instructions further cause the system to split the development dataset into the training dataset and the testing dataset based on a mask array generated by an optimized data split machine learning model, and output the training dataset and the testing dataset.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle.

FIG. 2 is a block diagram of an autonomous vehicle.

FIG. 3A is a schematic diagram showing data of an environment in which an autonomous vehicle could operate.

FIG. 3B is a schematic diagram of an example data split computing device for developing the autonomy computing system showing in FIG. 2.

FIG. 4A is a histogram of distribution of headings in an example development dataset, where the development dataset is to be split into a training dataset and a testing dataset using the data split computing device illustrated in FIG. 3B.

FIG. 4B is a histogram of distribution of headings in the training dataset split from the development dataset illustrated in FIG. 4A, using the data split computing device illustrated in FIG. 3B.

FIG. 4C is a histogram of distribution of headings in the testing dataset split from the development dataset illustrated in FIG. 4A, using the data split computing device illustrated in FIG. 3B.

FIG. 5 is a flow chart of an example method for data splitting.

FIG. 6A is a schematic diagram of a neural network model.

FIG. 6B is a schematic diagram of a neuron in the neural network model shown in FIG. 6A.

FIG. 7 is a block diagram of an example computing device.

FIG. 8 is a block diagram of an example user computing device.

FIG. 9 is a block diagram of an example server computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Systems and methods of data splitting for developing autonomy computing systems of autonomous vehicles are provided. An autonomy computing system of an autonomous vehicle perceives the environment in which the autonomous vehicle operates. An autonomy computing system includes one or more machine learning models. Training and testing datasets are used in developing the machine learning model, where the training dataset is used to train the machine learning model, and the testing dataset is used to test the performance of the trained machine learning model. Data for developing an autonomy computing system may be referred to as a development dataset, which may include data in various environments in which an autonomous vehicle could operate. Development datasets may be from various sources. For example, development datasets may include data collected by autonomous vehicles or simulated data by data generators. Development dataset may also include data collected by non-autonomous vehicles, traffic data collected by equipment such as roadside and/or aerial cameras, and/or other data suitable for developing autonomy computing systems of autonomous vehicles.

A development dataset is split into a training dataset and a testing dataset. The training and testing datasets do not overlap to maintain the integrity of testing. The distribution between the training dataset and the testing dataset should be balanced such that the testing dataset accurately tests the performance of the autonomy computing system trained with the training dataset. As used herein, a training dataset and a testing dataset being balanced refers to balanced distribution of operating conditions between the training dataset and the testing dataset. Testing an autonomous vehicle may be based on operating conditions under operational development domains (ODDs). ODDs are operating conditions under which autonomous driving features of an autonomous vehicle can operate safely. Example operating conditions include classes of objects in the environment in which the autonomous vehicle is operating, ranges of objects, headings of objects, weather conditions, or time of day. Distribution of an operating condition refers to probability of the operating condition in a dataset. Distribution of an operating condition may be determined as a percentage of data that have the operating condition, and a balanced distribution of an operating condition may be that a percentage of the operating condition in the training dataset and a percentage of the operating condition in the testing dataset is the same or the difference between the two percentage values is within a predefined threshold. Testing results may be biased or inaccurate if the training dataset and the testing dataset are not balanced, because the autonomy computing system may be trained for some operating conditions but are not tested, or the autonomy computing system may be tested on some operation conditions that the autonomy computing system has not been trained with.

Balancing a testing dataset and a training dataset in splitting a development dataset is a complex and difficult problem because a development data is relatively large and the number of operating conditions that should be considered is relatively large, resulting in a problem of a relatively high dimension with a relatively large dataset. Such a problem is difficult and places a high demand on memory and computation power.

Systems and methods described herein address the above-described problems using a data split machine model to split a development dataset into balanced training and testing datasets, thereby reducing bias in developing an autonomy computing system of an autonomous vehicle using the development dataset. The balance between the training dataset and the testing dataset is achieved by optimizing a cost function of the data split machine model that includes the distribution difference between the training dataset and the testing dataset. Systems and methods described herein are advantageous in solving the multi-dimensional problem of splitting a development dataset for an autonomy computing system without a heavy demand on computation resources, such as memory and/or or computation power.

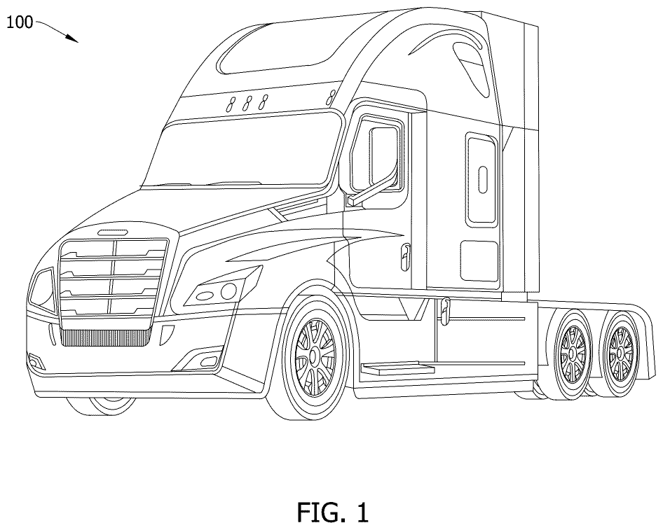

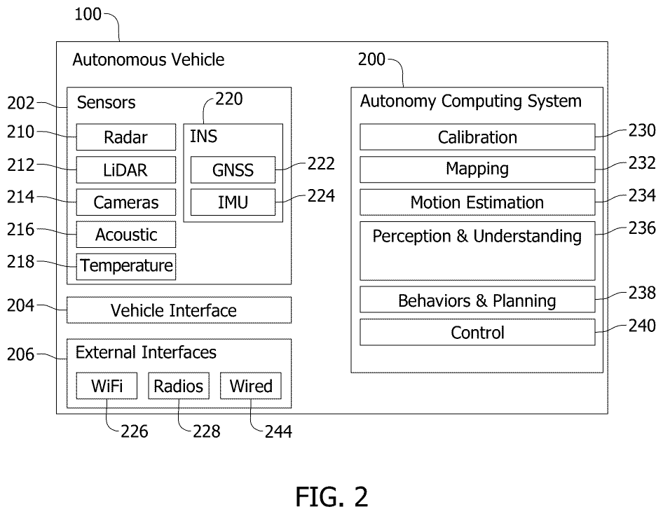

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operation of autonomous vehicle 100.

Cameras 214 may include RGB cameras, which are configured to capture images based on visible light. Cameras 214 may further include a gated camera, such as gated near infrared (NIR) camera. A gated camera is configured to capture images based on invisible light, such as NIR light. Cameras 214 are configured to capture images of the environment surrounding autonomous vehicle 100 in any aspect or field of view (FOV). The FOV can have any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous), semi-autonomous, or with any level of autonomy. In one example, autonomy computing system 200 can operate under Level 5 autonomy (e.g., full driving automation), Level 4 autonomy (e.g., high driving automation), Level 3 autonomy (e.g., conditional driving automation), Level 2 autonomy (e.g., partial driving automation), or Level 1 autonomy (e.g., driver assistance). As used herein the term “autonomous” includes fully autonomous, semi-autonomous, or having any level of autonomy.

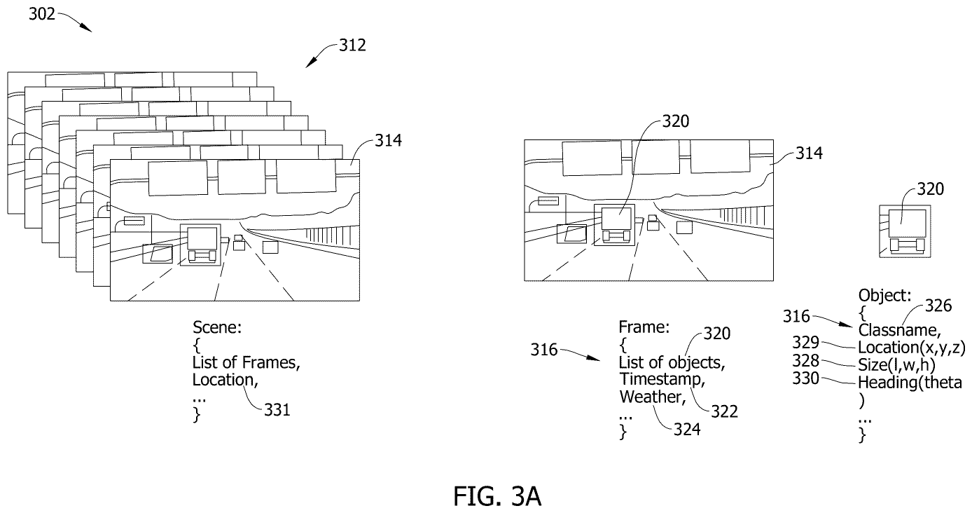

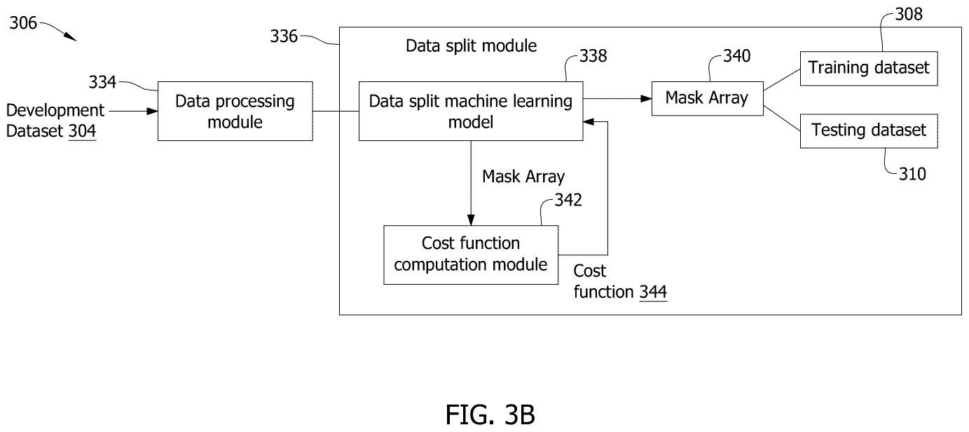

FIG. 3A is a schematic diagram of development data 302 in a development dataset 304 used in developing autonomy computing system 200 of autonomous vehicle 100. FIG. 3B is a schematic diagram of a data split computing device 306 configured to split development dataset 304. In developing an autonomous vehicle, development data 302 are used. Development data 302 may be in a training dataset 308 that is used to train autonomy computing system 200 of autonomous vehicle 100 (see FIGS. 1 and 2) such that the autonomy computing system performs the tasks as designed and meets requirements stipulated under industry standards or test progression plans. Development data may be in a testing dataset 310 that is used to test the performance of trained autonomy computing system 200. Development data 302 may be annotated, where labels marking features in the data are provided. Example labels may be objects in the environments, properties of the objects, such as classes of the objects, ranges of the objects, and/or headings of the objects, weather conditions, time of day, road conditions, and/or geographic locations.

In the example embodiment, development data 302 are in scenes 312. Scene 312 includes a temporal series of frames 314. A frame is an instance of the environment around autonomous vehicle 100 at a timepoint. For example, a scene 312 is of driving on a highway for a period of time, such as 10 seconds(s). Scene 312 is sampled at a sampling rate, such as 100 milliseconds (ms), into frames 314. As a result, scene 312 includes 100 frames 314. A frame 314 includes one or more operating conditions 316, such as a list of objects 320, a timestamp 322, or weather 324. Each operating condition 316 may include sub-operating conditions 316. For example, an object 320 includes a class name 326 of object 320, a location 329 at (x, y, z) of the object 320, a size 328 in (length (l), width (w), height (h)) of object 320, or heading or orientation (θ) 330 of object 320. In the depicted example, scene 312 is represented with parameters and/or operating conditions such as a list of frames 314 and a geographical location 331 of scene 312 (e.g., state of New Mexico or Interstate 40). Frame 314 is represented with parameters and/or operating conditions such as a list of objects 320 in frame 314, timestamp 322 of frame 314, and weather 324 of frame 314. Object 320 in frame 314 is represented with operating conditions such as class name 326, location 329 of (x, y, z), size 328 of (l, w, h), and heading 330 of θ.

Development data 302 typically include a relatively large number of scenes 312, which in turn includes a relatively large number of frames 314 and each frame 314 has one or more operating conditions 316. To reduce bias of developed autonomy computing system 200 towards training dataset 308 or testing dataset 310, distribution of operating conditions 316 in training dataset 308 and testing dataset 310 should be balanced. For example, if training dataset 308 includes 80% of passenger vehicles, testing dataset 310 should also include 80% of passenger vehicles. As the number of operating conditions being considered increases, dimensionality in splitting development dataset 304 increases, leading to drastic increases in the complexity and difficulty in solving the problem, due to drastic increases in the amount of data and complexity from the increase in dimensionality. Further, an additional challenge in solving the problem of splitting data for developing autonomy computing system 200 is that frames 314 in a scene 312 should not be split between training dataset 308 and testing dataset 310 because frames 314 in a scene 312 resemble one another due to proximity in time. During testing, testing dataset 310 should include data with which autonomy computing system 200 has not been trained to increase the independence of the testing results. Therefore, training and testing autonomy computing system 200 should not use frames 314 from the same scene 312, such that testing results reflect the performance of autonomy computing system 200, instead reflecting only how well autonomy computing system 200 is fitted to the scenarios in the training dataset.

In the example embodiment, a data split computing device 306 is configured to split development dataset 304 into training dataset 308 and testing dataset 310. Data split computing device 306 includes a data processing module 334 configured to process development data 302 by representing scenes 312 in condition vectors of one or more dimensions. A dimension of a condition vector represents an operating condition in the environment in which an autonomous vehicle could operate. A value of that dimension represents one or more occurrences of the operating condition in scene 312. Operating conditions may be selected based on ODDs of autonomy computing system 200. Operating conditions included in condition vectors may be related to objects in the environments, such as classes of objects, ranges of objects, or headings of objects. A classes of an object refers to the classification and/or subclassification of the object, such as dynamic objects like a vehicle, a pedestrian, or a cyclist, or static objects like a temporary barrier. A range of an object refers to a range of the relative distance of the object from the autonomous vehicle acquiring the data. Ranges, such as 0 -50 meters (m), 50-100 m, 150-200 m, or 200 m or greater, may be used. A heading of an object refers to the angle between the facing direction of the object and the autonomous vehicle acquiring the data. A heading may be represented in ranges, such as −30 to 30 degrees, 30 to 90 degrees, and −90 to −30 degrees. Operating conditions related to the time of day, such as day or night, may also be included in condition vectors. Operating conditions included in condition vectors may also be related to the weather condition, such as raining, sunny, or snowing. In some embodiments, operating conditions related to geographical locations, such as regions or states, are included, and/or operating conditions related to certain highways are included, such as Interstate 95.

In the example embodiment, the condition vector corresponding to scene 312 is constructed at the frame level and determined based on the condition vectors of frames 314 in scene 312. For example, nine operating conditions are included for the condition vector. The number of dimensions of the condition vector is nine. The condition vector is presented as a nine-dimensional vector in the format of a tuple of coordinates in the nine dimensions, such as [class name a, class name b, class name c, heading (−30 to 30 degrees), heading (−90 to −30 degrees), heading (30 to 90 degrees), range (0 -50 m), range (50-100 m), range (100-150 m)]. For each frame 314, a condition vector is generated by assigning a value representing one or more occurrences that the frame 314 has the specific operating conditions included in the condition vector. An object represented as {class a, location (10, 10, 0), size (2, 5, 6), heading (20)} may update the vector to [1, 0, 0, 1, 0, 0, 1, 0, 0]. A condition vector of [1, 2, 4, 4, 1, 2, 1, 2, 4] of frame 314 represents frame 314 includes one object in class a, two objects in class b, four objects in class c, among the seven objects, four of them having headings in the range from −30 to 30 degrees, one having a heading in the range from −90 to −30 degrees, and two being in the range from 30 to 90 degrees, one being in the range of 0 -50 m, two in the range of 50-100 m, and four in the range of 100-150 m from the autonomous vehicle acquiring frame 314.

In the example embodiment, frames 314 in one scene 312 are not split between training dataset 308 and testing dataset. To that end, for one scene 312, only one condition vector is generated during splitting of development dataset 304. The condition vector of scene 312 is determined based on condition vectors of frames 314 in that scene 312. Condition vectors of frames 314 in a scene 312 may be summed to derive the condition vector of scene 312. For example, if scene 312 includes 100 frames, and each frame 314 is represented with a condition vector, the condition vector of scene 312 is determined as a sum of the 100 condition vectors of 100 individual frames 314.

In the example embodiment, data split computing device 306 further includes a data split module 336. Data split module 336 includes data split machine learning model 338. Condition vectors of scenes 312 are input into data split machine learning model 338. Data split machine learning model 338 is configured to take condition vectors as inputs and generate a mask array 340. Mask array 340 is an array having a length, or a number of elements, the same as the number of scenes 312 in development dataset 304. An element of mask array 340 indicates whether a scene 312 in development dataset 304 is to be allocated to training dataset 308 or testing dataset 310. The indicator may be a number, such as “1” indicating to be allocated to training dataset 308 and “0 ” indicating to be allocated to testing dataset 310. Data split machine learning model 338 may be a neural network model, such as a fully-connected neural network model or a convolutional neural network model.

In the depicted embodiment, data processing module 334 is separate from data split machine learning model 338, where processed development data output from data processing module 334 are input into data split machine learning model 338. In some embodiments, data processing module 334 is included in data split machine learning model 338. Data split machine learning model 338 takes development dataset 304 as an input and includes one or more layers of neurons performing functions of data processing module 334 that represents scenes 312 of development dataset 304 in condition vectors.

In the example embodiment, data split module 336 further includes a cost function computation module 342 configured to compute a cost function 344. Data split module 336 is configured to split development dataset 304 into training dataset 308 and testing dataset 310 having balanced distribution of operating conditions, using regression. In one example, data split machine learning model 338 is optimized by optimizing cost function 344 of data split machine learning model 338 such that optimized data split machine learning model 338 generates a mask array based on which development dataset 304 is split into training dataset 308 and testing dataset 310 having balanced distribution of operation conditions.

In the example embodiment, cost function computation module 342 is configured to compute a distribution difference c-d indicating a balance level between training dataset 308 and testing dataset 310. The distribution difference may be computed based on a difference vector. The difference vector is computed as the difference between a training sum vector and a testing sum vector. The training sum vector is computed by summing the condition vectors of scenes 312 to be allocated to training dataset 308. The testing sum vector is computed by summing condition vectors of scenes 312 to be allocated to testing dataset 310. The training sum vector and the testing sum vector may be normalized and the difference vector is computed based on the normalized training sum vector and the normalized testing sum vector, because training dataset 308 typically have more scenes than testing dataset 310. In normalizing, a total sum vector is computed by summing all condition vectors of all scenes 312 in development dataset 304. The normalized training sum vector is computed by dividing, dimension by dimension, the training sum vector by the total sum vector. The normalized testing sum vector is computed by dividing, dimension by dimension, the testing sum vector by the total sum vector. For example, a training sum vector is [TN1, TN2, . . . TNn], the testing sum vector is [TT1, TT2, . . . TTn], and the total sum vector is [S1, S2, . . . Sn], where n is the number of dimensions or operating conditions in condition vectors. The normalized training sum vector is computed as [TN1/S1, TN2/S2, . . . TNn/Sn]. The normalized testing sum vector is computed as [TT1/S1, TT2/S2, . . . TTn/Sn].

In the example embodiment, distribution difference c-d is computed as a sum of absolute values of coordinates in the difference vector. For example, if the difference vector is [D1, D2, . . . Dn], distribution difference c-d is computed as the sum of the absolute values of D1, the absolute value of D2, . . . and the absolute value of Dn. Distribution difference c-d is in the range from 0 to the number of dimensions of the condition vectors, or the number of operating conditions in the condition vectors.

In the example embodiments, the cost function 344 may further include a ratio difference c-r. Ratio difference c-r indicates the difference between a predefined split ratio between training dataset 308 and testing dataset 310 and a split ratio according to mask array 340. A predefined split ratio between training dataset 308 and testing dataset 310 may be 0.8. The split ratio according to mask array 340 may be computed by summing values of elements in mask array 340 and dividing the sum by the size of mask array 340 or the number of scenes 312 in development dataset 304. An absolute value of the difference between the split ratio based on mask array 340 and the predefined split ratio may be used as ratio difference c-r for indicating the deviation of the split according to mask array 340 from the predefined split ratio, either being greater or small than the predefined split ratio. The ratio difference is in the range from 0 to 1.

In the example embodiments, the cost function is a weighted sum of distribution difference c-d and ratio difference c-r. Distribution difference c-d is weighted by a first weighting w1. Ratio difference c-r is weighted by a second weighting w2. First weighting w1 and/or second weighting w2 may be user defined. An increased first weighting w1 places increased weight on balanced distribution between training dataset 308 and testing dataset 310. An increased weighting w2 places increased weight on the split ratio being proximate to the predefined split ratio.

In the example embodiment, during optimization, cost function 344 is optimized by adjusting data split machine learning model 338, such as by adjusting weights of neurons in data split machine learning model 338, to reduce cost function 344. Cost function 344 is optimized when the cost function is stabilized. For example, the cost function is stabilized or optimized when the difference between the cost function from the current iteration and the cost function from a prior iteration is within a predefined threshold. After optimization, data split machine learning model 338 is optimized for splitting development dataset 304 into training dataset 308 and testing dataset 310 having balanced distribution of operating conditions. Mask array 340, generated by optimized data split machine learning model 338, is used to split development dataset 304 into training dataset 308 and testing dataset 310 that have balanced distribution of operating conditions between training dataset 308 and testing dataset 310. For example, Scenes 312 in development dataset 304 are arranged as an ordered list. Mask array 340 is in 1's and 0's with the indexes of elements corresponding to the orders of scenes 312 in the ordered list. For an element in mask array 340 having an index i, “1” indicates that the corresponding scene having the order in the ordered list as the index i, or the ith scene 312 in development dataset 304, is to be allocated to training dataset 308, and “0 ” indicates that the corresponding scene having the order in the ordered list as the index i, or the ith scene, is to be allocated to testing dataset. Mask array 340 is applied as a mask over development dataset 304, where scenes 312 having mask values of 1 are allocated to training dataset 308, while scenes 312 having mask values of 0 are allocated to testing dataset 310. Training dataset 308 and testing dataset 310 are output by data split computing device 306 for developing autonomy computing system 200.

In some embodiments, data split machine learning model 338 includes one or more layers of neurons configured to split development dataset 304 into training dataset 308 and testing dataset 310 based on mask array 340 generated by optimized data split machine learning model 338.

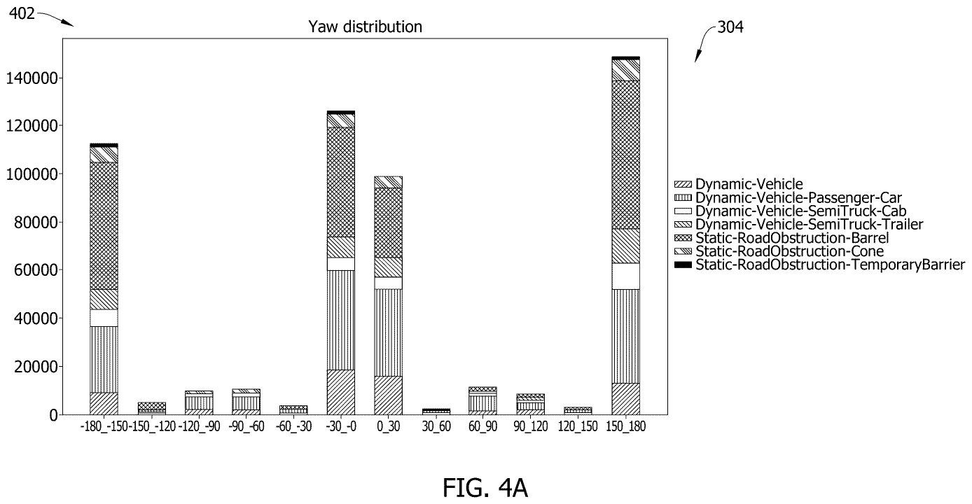

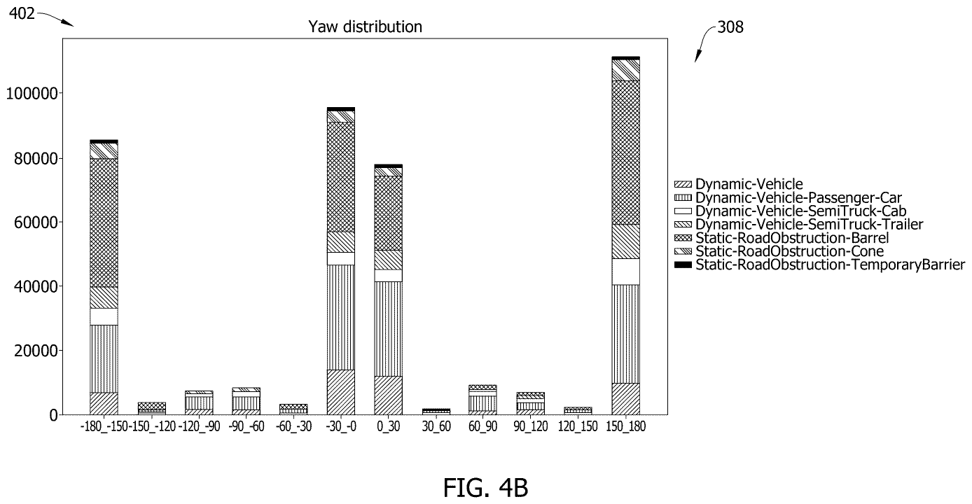

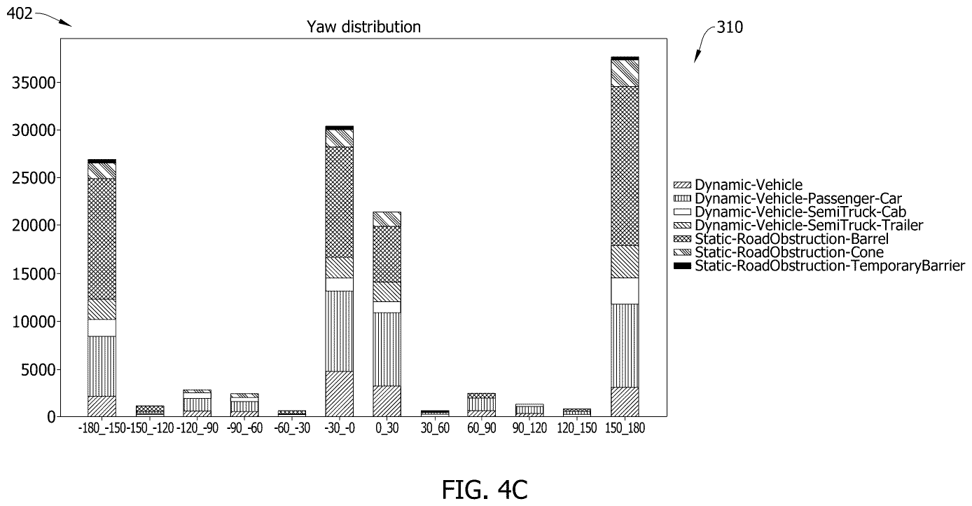

In some embodiments, histograms 402 (see FIGS. 4A-4C) are generated to provide visual depiction and comparison of the distribution of operating conditions in development dataset 304, training dataset 308, and/or testing dataset 310. FIG. 4A shows distribution of headings of objects in the environments of scenes 312 (see FIG. 3A) in development dataset 304. FIG. 4B shows distribution of headings in training dataset 308 split from development dataset 304 using systems and methods described herein. FIG. 4C shows distribution of headings in testing dataset split from development dataset 304 using systems and methods described herein. As shown in FIGS. 4B and 4C, different classes of objects and overall distribution of headings are balanced between training dataset 308 and testing dataset 310.

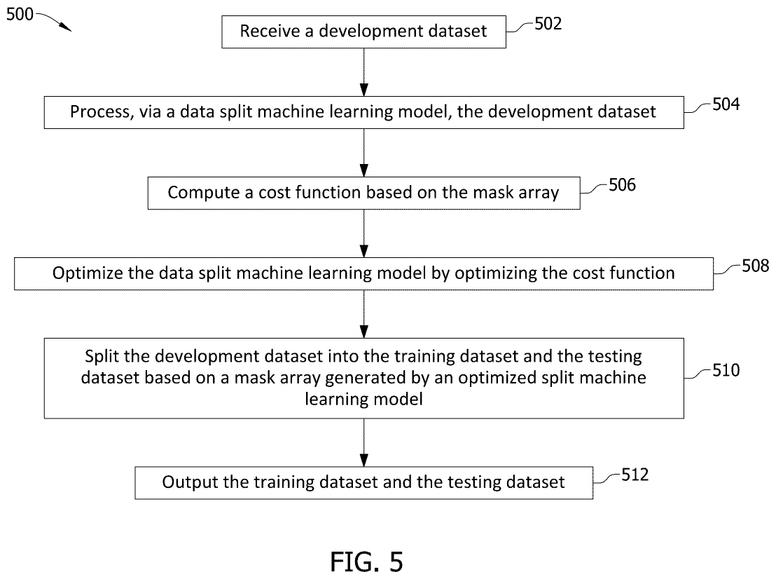

FIG. 5 is a flow chart of an example method 500 of data splitting. In the example embodiment, method 500 includes receiving 502 a development dataset. Method 500 further includes processing 504, via a data split machine learning model, the development dataset. Development dataset 304 includes a plurality of scenes 312. Example data split machine learning models are data split machine learning model 338 described herein. Data split machine learning model 338 is configured to generate mask array 340, which indicates whether a scene 312 of plurality of scenes 312 is to be allocated to training dataset 308 or testing dataset 310. Method 500 further includes computing 506 a cost function based on the mask array. In addition, method 500 includes optimizing 508 the data split machine learning model by optimizing the cost function to balance distribution of one or more operating conditions between the training dataset and the testing dataset. Method 500 also includes splitting 510 the development dataset into the training dataset and the testing dataset based on an mask array generated by the optimized data split machine learning model. Method 500 further includes outputting 512 the training dataset and the test dataset.

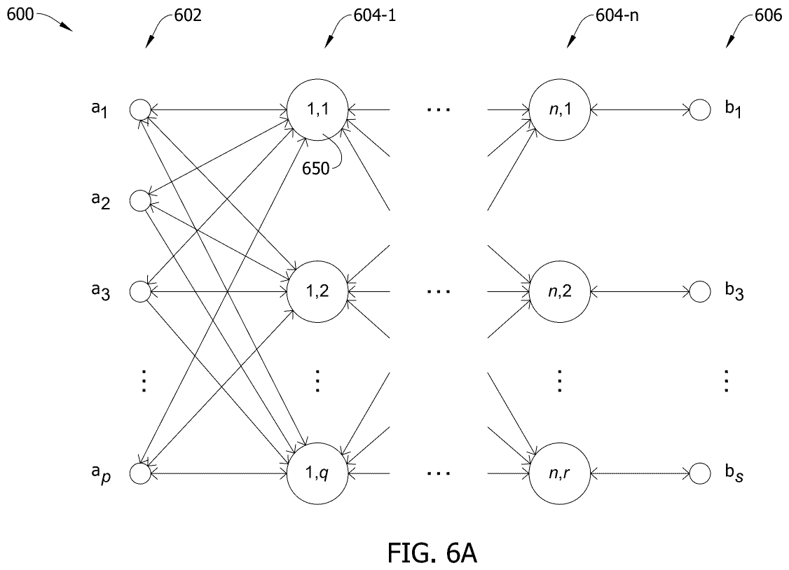

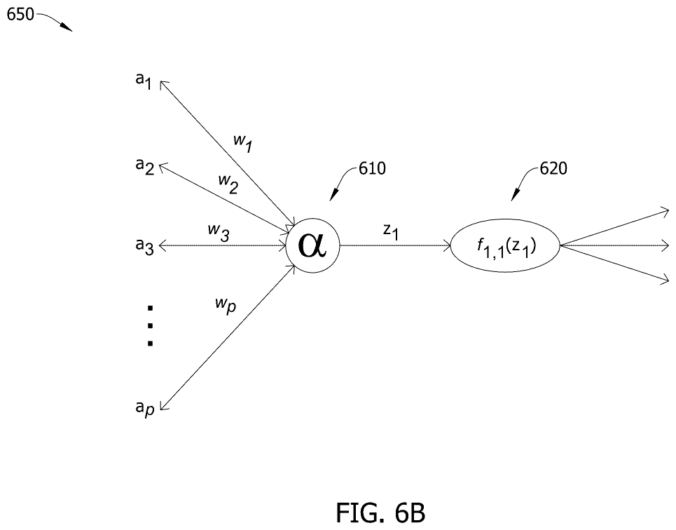

FIG. 6A depicts an example artificial neural network model 600. Data split machine learning model 338 may include one or more neural network models 600. The example neural network model 600 includes layers of neurons 650, 604-1 to 604-n, and 606, including an input layer 602, one or more hidden layers 604-1 through 604-n, and an output layer 606. Each layer may include any number of neurons, i.e., q, r, and n in FIG. 6A may be any positive integer. It should be understood that neural networks of a different structure and configuration from that depicted in FIG. 6A may be used to achieve the methods and systems described herein.

In the example embodiment, the input layer 602 may receive different input data. For example, the input layer 602 includes a first input a₁ representing training images, a second input a₂ representing patterns identified in the training images, a third input a₃ representing edges of the training images, and so on. The input layer 602 may include thousands or more inputs. In some embodiments, the number of elements used by the neural network model 600 changes during the training process, and some neurons are bypassed or ignored if, for example, during execution of the neural network, they are determined to be of less relevance.

In the example embodiment, each neuron in hidden layer(s) 604-1 through 604-n processes one or more inputs from the input layer 602, and/or one or more outputs from neurons in one of the previous hidden layers, to generate a decision or output. The output layer 606 includes one or more outputs each indicating a label, confidence factor, weight describing the inputs, and/or an output image. In some embodiments, however, outputs of the neural network model 600 are obtained from a hidden layer 604-1 through 604-n in addition to, or in place of, output(s) from the output layer(s) 606.

In some embodiments, each layer has a discrete, recognizable function with respect to input data. For example, if n is equal to 3, a first layer analyzes the first dimension of the inputs, a second layer the second dimension, and the final layer the third dimension of the inputs. Dimensions may correspond to aspects considered strongly determinative, then those considered of intermediate importance, and finally those of less relevance.

In other embodiments, the layers are not clearly delineated in terms of the functionality they perform. For example, two or more of hidden layers 604-1 through 604-n may share decisions relating to labeling, with no single layer making an independent decision as to labeling.

FIG. 6B depicts an example neuron 650 that corresponds to the neuron labeled as “1,1” in hidden layer 604-1 of FIG. 6A, according to one embodiment. Each of the inputs to the neuron 650 (e.g., the inputs in the input layer 602 in FIG. 6A) is weighted such that input a₁ through aₚ corresponds to weights w₁ through wₚ as determined during the training process of the neural network model 600.

In some embodiments, some inputs lack an explicit weight, or have a weight below a threshold. The weights are applied to a function α (labeled by a reference numeral 610), which may be a summation and may produce a value z₁ which is input to a function 620, labeled as f_{1,1}(z₁). The function 620 is any suitable linear or non-linear function. As depicted in FIG. 6B, the function 620 produces multiple outputs, which may be provided to neuron(s) of a subsequent layer, or used as an output of the neural network model 600. For example, the outputs may correspond to index values of a list of labels, or may be calculated values used as inputs to subsequent functions.

It should be appreciated that the structure and function of the neural network model 600 and the neuron 650 depicted are for illustration purposes only, and that other suitable configurations exist. For example, the output of any given neuron may depend not only on values determined by past neurons, but also on future neurons.

The neural network model 600 may include a convolutional neural network (CNN), a deep learning neural network, a reinforced or reinforcement learning module or program, or a combined learning module or program that learns in two or more fields or areas of interest. Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. The neural network model 600 may be trained using unsupervised machine learning programs. In unsupervised machine learning, the processing element may be required to find its own structure in unlabeled example inputs. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics, and information. The machine learning programs may use deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing—either individually or in combination. The machine learning programs may also include natural language processing, semantic analysis, automatic reasoning, and/or machine learning.

Based upon these analyses, the neural network model 600 may learn how to identify characteristics and patterns that may then be applied to analyzing image data, model data, and/or other data. For example, the model 600 may learn to identify features in a series of data points.

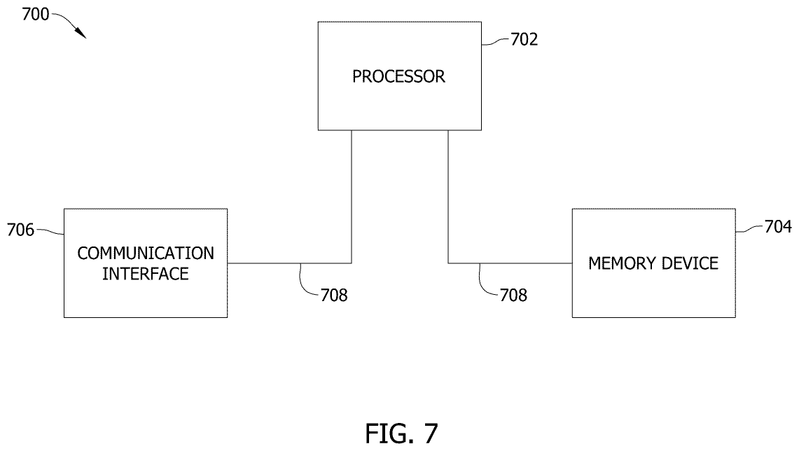

FIG. 7 is a block diagram of an example computing device 700. Autonomy computing system 200 may be implemented with one or more computing devices 700. In the example embodiment, computing device 700 includes a processor 702 and a memory device 704. The processor 702 is coupled to the memory device 704 via a system bus 708. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 704 includes one or more devices that enable information, such as executable instructions or other data (e.g., sensor data), to be stored and retrieved. Moreover, the memory device 704 includes one or more computer readable media, such as, without limitation, dynamic random access memory (DRAM), static random access memory (SRAM), a solid state disk, or a hard disk. In the example embodiment, the memory device 704 stores, without limitation, application source code, application object code, configuration data, additional input events, application states, assertion statements, validation results, or any other type of data. The computing device 700, in the example embodiment, may also include a communication interface 706 that is coupled to the processor 702 via system bus 708. Moreover, the communication interface 706 is communicatively coupled to data acquisition devices.

In the example embodiment, processor 702 may be programmed by encoding an operation using one or more executable instructions and providing the executable instructions in the memory device 704. In the example embodiment, the processor 702 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

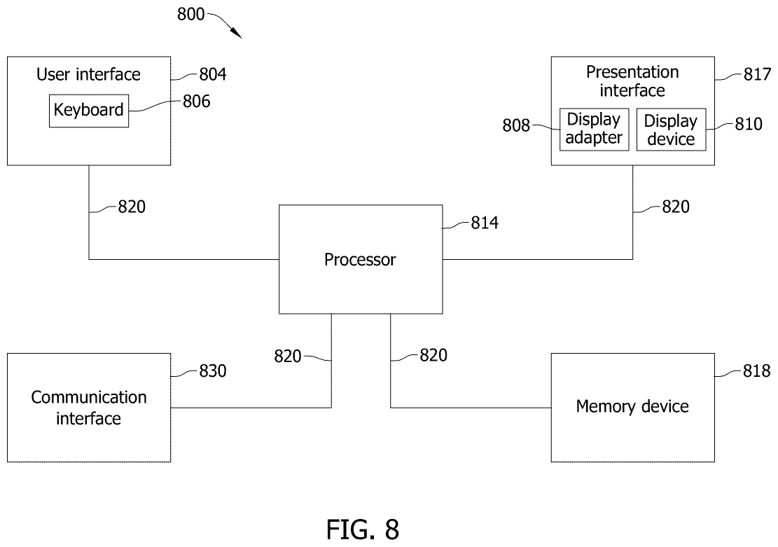

Data split computing device 306 described herein may be any suitable computing device 800 and software implemented therein. FIG. 8 is a block diagram of an example user computing device 800. In the example embodiment, computing device 800 includes a user interface 804 that receives at least one input from a user. User interface 804 may include a keyboard 806 that enables the user to input pertinent information. User interface 804 may also include, for example, a pointing device, a mouse, a stylus, a touch sensitive panel (e.g., a touch pad and a touch screen), a gyroscope, an accelerometer, a position detector, and/or an audio input interface (e.g., including a microphone).

Moreover, in the example embodiment, computing device 800 includes a presentation interface 817 that presents information, such as input events and/or validation results, to the user. Presentation interface 817 may also include a display adapter 808 that is coupled to at least one display device 810. More specifically, in the example embodiment, display device 810 may be a visual display device, such as a cathode ray tube (CRT), a liquid crystal display (LCD), a light-emitting diode (LED) display, and/or an “electronic ink” display. Alternatively, presentation interface 817 may include an audio output device (e.g., an audio adapter and/or a speaker) and/or a printer.

Computing device 800 also includes a processor 814 and a memory device 818. Processor 814 is coupled to user interface 804, presentation interface 817, and memory device 818 via a system bus 820. In the example embodiment, processor 814 communicates with the user, such as by prompting the user via presentation interface 817 and/or by receiving user inputs via user interface 804. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are for illustration purposes only, and thus are not intended to limit in any way the definition and/or meaning of the term “processor.”

In the example embodiment, memory device 818 includes one or more devices that enable information, such as executable instructions and/or other data, to be stored and retrieved. Moreover, memory device 818 includes one or more computer readable media, such as, without limitation, dynamic random access memory (DRAM), static random access memory (SRAM), a solid state disk, and/or a hard disk. In the example embodiment, memory device 818 stores, without limitation, application source code, application object code, configuration data, additional input events, application states, assertion statements, validation results, and/or any other type of data. Computing device 800, in the example embodiment, may also include a communication interface 830 that is coupled to processor 814 via system bus 820. Moreover, communication interface 830 is communicatively coupled to data acquisition devices.

In the example embodiment, processor 814 may be programmed by encoding an operation using one or more executable instructions and providing the executable instructions in memory device 818. In the example embodiment, processor 814 is programmed to select a plurality of measurements that are received from data acquisition devices.

In operation, a computer executes computer-executable instructions embodied in one or more computer-executable components stored on one or more computer-readable media to implement aspects of the invention described and/or illustrated herein. The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

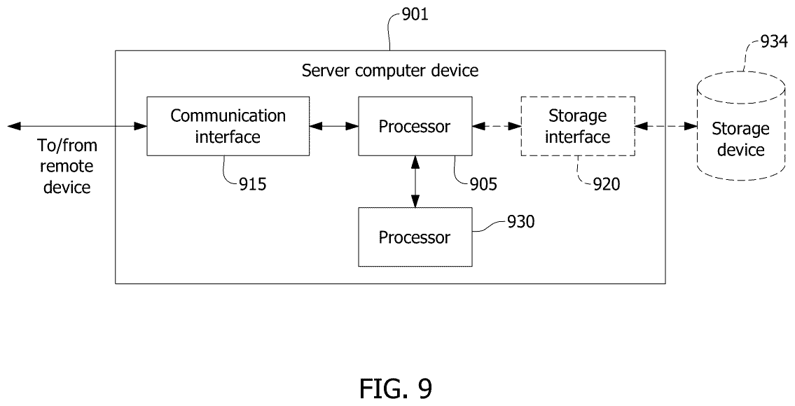

FIG. 9 illustrates an example configuration of a server computer device 901 such as data split computing device 306. Server computer device 901 also includes a processor 905 for executing instructions. Instructions may be stored in a memory area 930, for example. Processor 905 may include one or more processing units (e.g., in a multi-core configuration).

Processor 905 is operatively coupled to a communication interface 915 such that server computer device 901 is capable of communicating with a remote device or another server computer device 901. For example, communication interface 915 may receive data from system 12, via the Internet.

Processor 905 may also be operatively coupled to a storage device 934. Storage device 934 is any computer-operated hardware suitable for storing and/or retrieving data. In some embodiments, storage device 934 is integrated in server computer device 901. For example, server computer device 901 may include one or more hard disk drives as storage device 934. In other embodiments, storage device 934 is external to server computer device 901 and may be accessed by a plurality of server computer devices 901. For example, storage device 934 may include multiple storage units such as hard disks and/or solid state disks in a redundant array of independent disks (RAID) configuration. storage device 934 may include a storage area network (SAN) and/or a network attached storage (NAS) system.

In some embodiments, processor 905 is operatively coupled to storage device 934 via a storage interface 920. Storage interface 920 is any component capable of providing processor 905 with access to storage device 934. Storage interface 920 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 905 with access to storage device 934.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as conversation data of spoken conversations to be analyzed, mobile device data, and/or additional speech data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the conversation, statement, utterance, spoken word, typed word, geolocation data, and/or other data.

An example technical effect of the methods, systems, and apparatus described herein includes at least one of: (a) splitting a development dataset into a training dataset and a testing dataset that are balanced in operating conditions, thereby reducing bias in developing an autonomy computing system of an autonomous vehicle, or (b) balanced data splitting via a regression-based optimization of a machine learning model, thereby reducing computation complexity and demand.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable/machine-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A data split computing device for developing an autonomy computing system of an autonomous vehicle, comprising at least one processor in communication with at least one memory device, the at least one processor programmed to:
receive a development dataset having a plurality of scenes of environments in which an autonomous vehicle could operate, at least one of the plurality of scenes having one or more operating conditions in the environments, the development dataset to be used for developing an autonomy computing system of the autonomous vehicle;
process, via a data split machine learning model, the development dataset, wherein the data split machine learning model is configured to generate a mask array, the mask array indicating whether a scene in the plurality of scenes is to be allocated to a training dataset or a testing dataset of developing the autonomy computing system;
compute a cost function based on the mask array;
optimize the data split machine learning model by:
optimizing the cost function to balance distribution of the one or more operating conditions between the training dataset and the testing dataset;
split the development dataset into the training dataset and the testing dataset based on a mask array generated by an optimized data split machine learning model; and
output the training dataset and the testing dataset.

2. The data split computing device of claim 1, wherein the at least one processor is further programmed to:
process the plurality of scenes by:
representing the scene in a condition vector, wherein a dimension of the condition vector corresponds to an operating condition of the one or more operating conditions, and a value of the dimension represents one or more occurrences of the operating condition in the scene.

3. The data split computing device of claim 2, wherein the scene includes one or more frames, the at least one processor further programmed to:
represent the scene by:
representing the one or more frames in one or more condition vectors, each condition vector of the one or more frames corresponding to a frame of the one or more frames, wherein a value of the dimension in the each condition vector represents the one or more occurrences of the operating condition in the frame; and
summing the one or more condition vectors of the one or more frames into the condition vector of the scene.

4. The data split computing device of claim 2, wherein the at least one processor is further programmed to:
compute the cost function by:
computing a training sum vector by summing condition vectors of scenes to be allocated to the training dataset, based on the mask array;
computing a testing sum vector by summing condition vectors of scenes to be allocated to the testing dataset, based on the mask array;
computing a distribution difference based on the training sum vector and the testing sum vector; and
computing the cost function based on the distribution difference.

5. The data split computing device of claim 4, wherein:
computing the training sum vector further comprises normalizing the training sum vector;
computing the testing sum vector further comprises normalizing the testing sum vector; and
computing the distribution difference further comprises computing the distribution difference based on a normalized training sum vector and a normalized testing sum vector.

6. The data split computing device of claim 4, wherein the at least one processor is further programmed to:
compute the cost function by:
computing a split ratio based on the mask array;
computing a ratio difference between a computed split ratio and a predefined split ratio between the training dataset and the testing dataset; and
computing the cost function based on the distribution difference with a first weighting and the ratio difference with a second weighting.

7. The data split computing device of claim 6, wherein at least one of the first weighting or the second weighting is user defined.

8. The data split computing device of claim 1, wherein the at least one processor is further programmed to:
generate one or more histograms of distribution of the one or more operating conditions in at least one of the training dataset or the testing dataset; and
output the one or more histograms.

9. The data split computing device of claim 1, wherein the one or more operating conditions include a plurality of operating conditions.

10. A method of data splitting for developing an autonomy computing system of an autonomous vehicle, the method comprising:
receiving a development dataset having a plurality of scenes of environments in which an autonomous vehicle could operate, at least one of the plurality of scenes having one or more operating conditions in the environments, the development dataset to be used for developing an autonomy computing system of the autonomous vehicle;
processing, via a data split machine learning model, the development dataset, wherein the data split machine learning model is configured to generate a mask array, the mask array indicating whether a scene in the plurality of scenes is to be allocated to a training dataset or a testing dataset of developing the autonomy computing system;
computing a cost function based on the mask array;
optimizing the data split machine learning model by:
optimizing the cost function to balance distribution of the one or more operating conditions between the training dataset and the testing dataset;
splitting the development dataset into the training dataset and the testing dataset based on a mask array generated by an optimized data split machine learning model; and
outputting the training dataset and the testing dataset.

11. The method of claim 10, further comprising:
processing the plurality of scenes by:
representing the scene in a condition vector, wherein a dimension of the condition vector corresponds to an operating condition of the one or more operating conditions, and a value of the dimension represents one or more occurrences of the operating condition in the scene, the scene including one or more frames, representing the scene further comprising;
representing the one or more frames in one or more condition vectors, each condition vector of the one or more frames corresponding to a frame of the one or more frames, wherein a value of the dimension in the each condition vector represents the one or more occurrences of the operating condition in the frame; and
summing the one or more condition vectors of the one or more frames into the condition vector of the scene.

12. The method of claim 11, wherein computing the cost function further comprises:
computing a training sum vector by summing condition vectors of scenes to be allocated to the training dataset, based on the mask array;
computing a testing sum vector by summing condition vectors of scenes to be allocated to the testing dataset, based on the mask array;
computing a distribution difference based on the training sum vector and the testing sum vector; and
computing the cost function based on the distribution difference.

13. The method of claim 10, further comprising:
generating one or more histograms of distribution of the one or more operating conditions in at least one of the training dataset or the testing dataset; and
outputting the one or more histograms.

14. One or more non-transitory machine-readable storage media for data splitting for developing an autonomy computing system of an autonomous vehicle, the one or more non-transitory machine-readable storage media comprising a plurality of instructions stored thereon that, in response to being executed, cause a system to:
receive a development dataset having a plurality of scenes of environments in which an autonomous vehicle could operate, at least one of the plurality of scenes having one or more operating conditions in the environments, the development dataset to be used for developing an autonomy computing system of the autonomous vehicle;
process, via a data split machine learning model, the development dataset, wherein the data split machine learning model is configured to generate a mask array, the mask array indicating whether a scene in the plurality of scenes is to be allocated to a training dataset or a testing dataset of developing the autonomy computing system;
compute a cost function based on the mask array;
optimize the data split machine learning model by:
optimizing the cost function to balance distribution of the one or more operating conditions between the training dataset and the testing dataset;
split the development dataset into the training dataset and the testing dataset based on a mask array generated by an optimized data split machine learning model; and
output the training dataset and the testing dataset.

15. The one or more non-transitory machine-readable storage media of claim 14, wherein the plurality of instructions further cause the system to:
process the plurality of scenes by:
representing the scene in a condition vector, wherein a dimension of the condition vector corresponds to an operating condition of the one or more operating conditions, and a value of the dimension represents one or more occurrences of the operating condition in the scene.

16. The one or more non-transitory machine-readable storage media of claim 15, wherein the scene includes one or more frames, and the plurality of instructions further cause the system to:
represent the scene by:
representing the one or more frames in one or more condition vectors, each condition vector of the one or more frames corresponding to a frame of the one or more frames, wherein a value of the dimension in the each condition vector represents the one or more occurrences of the operating condition in the frame; and
summing the one or more condition vectors of the one or more frames into the condition vector of the scene.

17. The one or more non-transitory machine-readable storage media of claim 15, wherein the plurality of instructions further cause the system to:
compute the cost function by:
computing a training sum vector by summing condition vectors of scenes to be allocated to the training dataset, based on the mask array;
computing a testing sum vector by summing condition vectors of scenes to be allocated to the testing dataset, based on the mask array;
computing a distribution difference based on the training sum vector and the testing sum vector; and
computing the cost function based on the distribution difference.

18. The one or more non-transitory machine-readable storage media of claim 17, wherein:
computing the training sum vector further comprises normalizing the training sum vector;
computing the testing sum vector further comprises normalizing the testing sum vector; and
computing the distribution difference further comprises computing the distribution difference based on a normalized training sum vector and a normalized testing sum vector.

19. The one or more non-transitory machine-readable storage media of claim 17, wherein the plurality of instructions further cause the system to:
compute the cost function by:
computing a split ratio based on the mask array;
computing a ratio difference between a computed split ratio and a predefined split ratio between the training dataset and the testing dataset; and
computing the cost function based on the distribution difference with a first weighting and the ratio difference with a second weighting.

20. The one or more non-transitory machine-readable storage media of claim 14, wherein the plurality of instructions further cause the system to:
generate one or more histograms of distribution of the one or more operating conditions in at least one of the training dataset or the testing dataset; and
output the one or more histograms.
